(19) United States
(12) Patent Application Publication
(10) Pub. No.: US 2016/0012110 A1
(43) Pub. Date: Jan. 14, 2016

(54) GENERAL AND AUTOMATIC APPROACH TO INCREMENTALLY COMPUTING SLIDING WINDOW AGGREGATES IN STREAMING APPLICATIONS

(71) Applicant: INTERNATIONAL BUSINESS MACHINES CORPORATION, Armonk, NY (US)

(72) Inventors: Martin J. Hirzel, Westchester, NY (US); Scott A. Schneider, White Plains, NY (US); Kanat Tangwongsan, Bangkok (TH); Kun-Lung Wu, Yorktown Heights, NY (US)

(21) Appl. No.: 14/325,568

(22) Filed: Jul. 8, 2014

(51) Int. Cl. G06F 17/30

(52) U.S. Cl. CPC G06F 17/30516; G06F 17/30327; G06F 17/30342

(57) ABSTRACT

A method of incrementally computing an aggregate function of a sliding window in a streaming application includes receiving a plurality of data tuples in the sliding window, extracting at least one data tuple from the sliding window, and storing the at least one extracted data tuple in a data structure in a memory. The data structure is a balanced tree and the at least one data tuple is stored in leaf nodes of the balanced tree. The method further includes maintaining at least one intermediate result in at least one internal node of the balanced tree. The at least one intermediate result corresponds to a partial window aggregation. The method further includes generating a final result in the balanced tree based on the at least one intermediate result, and outputting the final result from the balanced tree. The final result corresponds to a final window aggregation.

### BACKGROUND

1. Technical Field

Exemplary embodiments of the present invention relate to stream processing, and more particularly, to a general, automatic, and incremental sliding window aggregation framework that can be utilized in stream processing.

2. Discussion of Related Art

Sliding window aggregation is a basic computation in stream processing applications. Streaming operators that compute sliding window aggregates such as, for example, the sum, average, count, and standard deviation of data tuples within a sliding window, are commonly used in streaming applications.

One approach to computing a sliding window aggregate includes recomputing the aggregate against all of the data in the window each time the window is changed due to the sliding in or sliding out of data tuples. However, since a streaming aggregate operator may be computationally intensive, the throughput of a streaming application may be limited. This throughput limitation may be more severe in scenarios in which the window size is large and/or the data rate is high. Another approach to computing a sliding window aggregate includes implementing an incremental method. However, such incremental methods are typically limited to simple aggregate functions such as, for example, sum and average functions, and are not suitable for aggregate functions that do not have an inverse such as, for example, min and max functions.

### SUMMARY

According to an exemplary embodiment of the present invention, a method of incrementally computing an aggregate function of a sliding window in a streaming application includes receiving a plurality of data tuples in the sliding window, extracting, by a processor, at least one data tuple of the plurality of data tuples from the sliding window, and storing the at least one extracted data tuple in a data structure in a memory. The data structure is a balanced tree and the at least one data tuple is stored in leaf nodes of the balanced tree. The method further includes maintaining, by the processor, at least one intermediate result in at least one internal node of the balanced tree. The at least one intermediate result corresponds to a partial window aggregation. The method further includes generating, by the processor, a final result in the balanced tree based on the at least one intermediate result. The final result corresponds to a final window aggregation. The method further includes outputting the final result from the balanced tree.

In an exemplary embodiment, maintaining the at least one intermediate result includes identifying at least one changed data item in a current data tuple of the plurality of data tuples currently in the sliding window. The at least one changed data item is relative to a previous data tuple of the plurality of data tuples previously in the sliding window. The method further includes extracting the at least one changed data item from the current data tuple, storing the at least one extracted changed data item in at least one of the leaf nodes of the balanced tree, and modifying the at least one intermediate result based on the at least one extracted changed data item.

In an exemplary embodiment, modifying the at least one intermediate result includes modifying a plurality of intermediate results stored in a plurality of internal nodes located at different levels within the balanced tree. The plurality of internal nodes are modified in the balanced tree using a bottom-up traversal.

In an exemplary embodiment, only internal nodes of the plurality of internal nodes affected by the at least one identified changed data item are modified.

In an exemplary embodiment, the at least one changed data item corresponds to new data added to the current tuple in the sliding window or old data removed from the current tuple in the sliding window.

In an exemplary embodiment, the method further includes modifying the final result in the balanced tree based on the at least one modified intermediate result.

In an exemplary embodiment, the method further includes storing the balanced tree in the memory in a pointer-free layout.

In an exemplary embodiment, the balanced tree is stored in the memory in a pointer-free array.

In an exemplary embodiment, the final result is stored in a root node of the balanced tree.

In an exemplary embodiment, the final result includes an output data tuple having an aggregate value based on an aggregation of all of the plurality of data tuples.

In an exemplary embodiment, the balanced tree is a binary tree.

According to an exemplary embodiment of the present invention, a computer program product for incrementally computing an aggregate function of a sliding window in a streaming application, the computer program product including a computer readable storage medium having program instructions embodied therewith, the program instructions executable by a processor to cause the processor to perform a method including receiving a plurality of data tuples in the sliding window, extracting at least one data tuple of the plurality of data tuples from the sliding window, and storing the at least one extracted data tuple in a data structure in a memory. The data structure is a balanced tree and the at least one data tuple is stored in leaf nodes of the balanced tree. The method further maintains at least one intermediate result in at least one internal node of the balanced tree. The at least one intermediate result corresponds to a partial window aggregation. The method further generates a final result in the balanced tree based on the at least one intermediate result. The final result corresponds to a final window aggregation. The method further outputs the final result from the balanced tree.

### BRIEF DESCRIPTION OF THE DRAWINGS

The above and other features of the present invention will become more apparent by describing in detail exemplary embodiments thereof with reference to the accompanying drawings, in which:

FIG. 1 shows pseudocode corresponding to a sliding window, according to an exemplary embodiment of the present invention.

FIG. 2 shows a general overview of change propagation being performed using the lift, combine, and lower functions with a balanced tree, according to an exemplary embodiment of the present invention.

FIG. 3 is a flowchart showing an overview of a reactive aggregator that incrementally computes an aggregate function of a sliding window of tuples in a streaming application, according to an exemplary embodiment of the present invention.

FIG. 4 shows an SPL code example that uses the Aggregate operator from the SPL standard library, according to an exemplary embodiment of the present invention.

FIG. 5 shows examples of aggregation operations, as well as their types and functions, that may be implemented using custom functions according to exemplary embodiments of the present invention.

FIG. 6 shows the algebraic properties of the operations listed in FIG. 5.

FIG. 7 shows an example of a fixed-sized aggregator (FAT) embodied as a binary tree having 8 leaf nodes, according to an exemplary embodiment of the present invention.

FIG. 8 shows pseudocode for a new function, according to an exemplary embodiment of the present invention.

FIG. 9 shows an example of an 8-leaf FAT tree being updated in response to modifications made to the tree, according to an exemplary embodiment of the present invention.

FIG. 10 shows pseudocode for an update function, according to an exemplary embodiment of the present invention.

FIG. 11 shows a process that performs a bottom-up leaf-to-root traversal in a balanced tree, according to an exemplary embodiment of the present invention.

FIG. 12 is a table showing the execution trace of running prefix(6) on the FAT structure shown in FIG. 7, according to an exemplary embodiment of the present invention.

FIG. 13 is a table showing a symmetric suffix operation relative to FIG. 11, according to an exemplary embodiment of the present invention.

FIG. 14 shows an example of a numbering scheme utilized by a FlatFAT implementation on a size-8 FAT, according to an exemplary embodiment of the present invention.

FIG. 15 shows the relationship between data stored in a physical representation and different logical representations, according to an exemplary embodiment of the present invention.

FIG. 16 shows a sequence of events issued by window logic when maintaining a sliding window keeping the latest four numbers, according to an exemplary embodiment of the present invention.

FIG. 17 is a flowchart showing a method of incrementally computing an aggregate function of a sliding window in a streaming application according to an exemplary embodiment of the present invention.

FIG. 18 is a flowchart showing a method of maintaining at least one intermediate result in a balanced tree while implementing a method of incrementally computing an aggregate function of a sliding window in a streaming application according to an exemplary embodiment of the present invention.

FIG. 19 illustrates a computer system for implementing aspects of exemplary embodiments of the present invention.

### DETAILED DESCRIPTION OF THE EXEMPLARY EMBODIMENTS

Exemplary embodiments of the present invention will be described more fully hereinafter with reference to the accompanying drawings. Like reference numerals may refer to like elements throughout the accompanying drawings.

Introduction

Stream processing may be used to compute timely insights from continuous data sources. Stream processing has widespread use cases including, for example, use cases in telecommunications, health care, finance, retail, transportation, social media, etc. A streaming application may involve some type of aggregation. For example, a trading application may aggregate the average price over the last 1,000 trades, or a network monitoring application may keep track of the total network traffic in the last 10 minutes.

Streaming aggregation may be performed over sliding windows. In stream processing, a window serves the purpose of defining the scope for an operation. Windows are utilized in stream processing because an application does not store an infinite stream in its entirety. Rather, windows summarize the data in a manner that is intuitive to the user, since the most recent data is typically the most relevant data. A sliding window may be defined in terms of time or the number of data objects in the window.

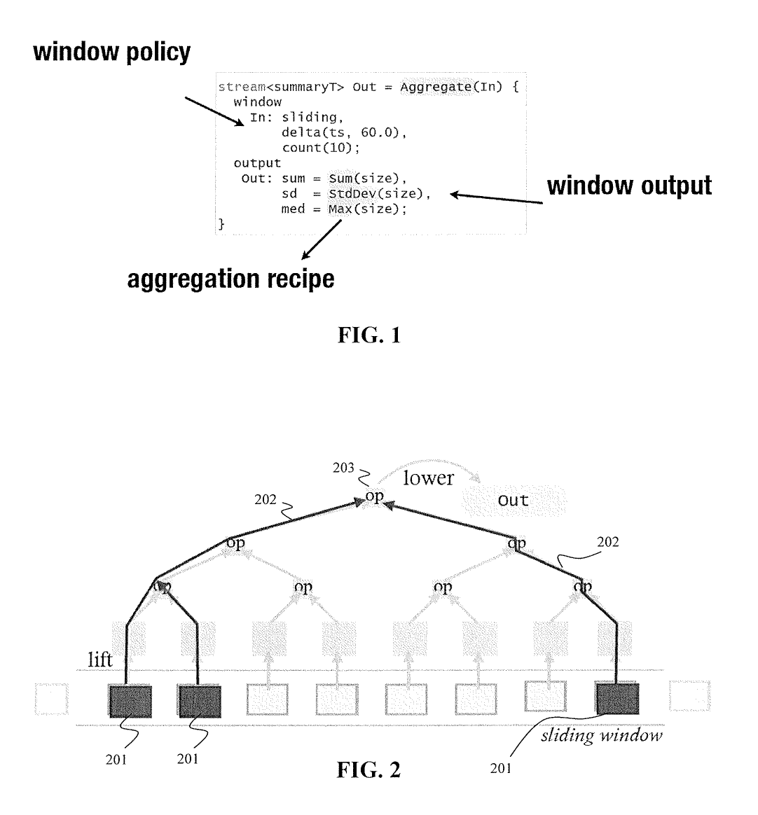

FIG. 1 shows pseudocode corresponding to a sliding window, according to an exemplary embodiment of the present invention.

Referring to FIG. 1, the window policy indicates what is displayed in the current window, and when to report the aggregation for the current window. In FIG. 1, the aggregation recipe describes the manner in which aggregation functions such as, for example, Sum, StdDev, and Max are computed. The window output indicates the type of aggregation to be produced, and when (e.g., how often) the aggregation results are to be generated. For example, the window policy in FIG. 1 indicates that data from the past 60 seconds is to be kept in the current window, and that for every 10 data tuples (e.g., data currently in the window that has a specific number and sequence of elements), the sum, standard deviation, and maximum of the data is to be computed.

Exemplary embodiments of the present invention provide a sliding window aggregation framework that is general, automatic, and incremental. Referring to the general nature of the framework according to exemplary embodiments, the framework works across a variety of aggregation operations, including, for example, operations that are not invertible (e.g., Min) or not commutative (e.g., First). Referring to the automatic nature of the framework according to exemplary embodiments, the application developer utilizing the framework is only presented with typical declarative choices of aggregations, and the library developer is shielded from lower-level aggregation code. Referring to the incremental nature of the framework, as tuples enter or leave a window, the framework may derive a solution without iterating over the entire window. That is, in an incremental framework according to exemplary embodiments, a sliding window aggregate may be computed without re-computing the aggregate against all of the data in the window each time the window is changed due to the sliding in or sliding out of data tuples.

General aggregations are useful for dealing with non-invertible or non-commutative cases. Examples of non-invertible aggregations include, for example, Min, Max, First, Last, and CollectDistinct. Examples of non-commutative aggregations include, for example, First, Last, Sum<String> (e.g., concatenation), Collect, and ArgMin. According to exemplary embodiments, a streaming application that supports user-defined aggregations may receive non-invertible and non-commutative cases that the streaming application is capable of handling.

Automatic aggregations are useful because aggregation frameworks often deal with a large number of cases and combinations such as, for example, different data types, aggregation functions, time-based vs. counter-based windows, and combined vs. partitioned windows. Performing aggregations automatically instead of manually may allow for the avoidance of the introduction of edge cases, which can potentially introduce maintenance problems. Exemplary embodiments of the framework provide a means for application developers and library developers to write custom aggregation operations.

Incremental aggregations are useful for performance reasons. For example, rescanning a window for every change may reduce performance as a result of causing spurious computation and unnecessarily using memory, which can lead to poor locality. Utilization of an incremental approach according to exemplary embodiments allows for partial results to be reused, which can result in a more efficient aggregation computation having improved algorithmic complexity and memory use.

A sliding window aggregation framework that is general, automatic, and incremental, according to exemplary embodiments of the present invention, may be referred to herein as a reactive aggregator, and may be implemented by combining an efficient data structure with a simplified abstraction for the library developer to program the aggregation operation, as described in further detail below. For example, exemplary embodiments of the present invention utilize custom functions that may be used to represent standard aggregation operations. That is, according to exemplary embodiments, standard aggregation operations may be expressed in terms of custom functions. These custom functions are referred to herein as lift, combine, and lower functions. Exemplary embodiments may implement these functions with a data structure (e.g., a balanced tree) to perform incremental aggregation. According to exemplary embodiments, aggregation operations of the reactive aggregator may be decomposed into lift, combine, and lower functions.

Generally, the lift function corresponds to an operation in which a data value that aggregation is to be applied to is extracted, or “lifted” out of the window, and stored in a data structure (e.g., a balanced tree). The combine function corresponds to an operation in which at least two data values are combined into a partial aggregation. The combine function is associative, and may or may not be commutative or invertible. Herein, the combine function may also be referred to as an op function. The lower function corresponds to an operation in which the data that is to be output is extracted from the data structure. For example, when the data structure is a balanced tree, the lower function corresponds to an operation in which data is taken from the root. Utilization of the lift, lower, and combine functions results in pointer-less operations. For example, according to exemplary embodiments, the reactive aggregator is not required to store pointers. Since the use of pointers may be a costly operation, the reactive aggregator according to exemplary embodiments of the present invention may result in an improved and more efficient application. The lift, combine, and lower functions are described in further detail below.

FIG. 2 shows a general overview of change propagation being performed using the lift, combine, and lower functions with a balanced tree, according to an exemplary embodiment of the present invention.

Referring to FIG. 2, the data structure (e.g., the balanced tree) is updated by propagating changes using a bottom-up traversal. For example, changes are propagated beginning with the leaf nodes of the balanced tree, moving up through the internal nodes from a lowest level to a highest level of internal nodes in the balanced tree, and ending with the root node of the balanced tree. First, changed data item(s) 201 for which aggregation is to be applied are extracted, or “lifted” out of the sliding window and into the data structure (e.g., the balanced tree) using the lift function. The changed data items 201 are relative to previous tuples in the sliding window. For example, the target data values are lifted into leaves of the balanced tree (e.g., the target data values corresponding to the changed data items 201 are extracted from the tuples in the sliding window and stored in leaves of the balanced tree). The combine function (e.g., the op function) is performed on internal nodes moving up the tree toward the root, and partial aggregations (e.g., intermediate results) are maintained throughout the tree at internal nodes of the tree based on the extracted changed data items 201. The combine function is performed for all internal nodes affected by the lift function (re-computation is only performed for affected nodes). In FIG. 2, the darkened lines 202 represent the portions of the tree at which incremental computation is performed. Incremental computation is not performed in the other portions of the tree. A new aggregate is then computed by executing the lower function at the root node 203, which generates final aggregation results which are then output from the root node 203.

According to exemplary embodiments, the reactive aggregator maintains a small number of partial results in addition to the final result, and responds to changes in the window by modifying a subset of the partial results affected by the changes, and in turn, regenerating the final result. The data structure utilized by the reactive aggregator, which may be referred to herein as the reactive aggregator data structure, may be, for example, a balanced tree, as described in further detail below. Embodying the data structure of the reactive aggregator in a balanced tree is memory efficient and computation efficient for its associated operations. The balanced tree may maintain the data tuples in the sliding window in the leaves of the tree, and may store partial aggregates in the internal nodes of the tree. The balanced tree may be packed into an array in memory in a pointer-free layout, avoiding pointer chasing during incremental aggregation computation.

As described above, the reactive aggregator data structure according to exemplary embodiments includes the custom lift, combine, and lower functions. Utilization of this data structure with these custom functions results in improved algorithmic complexity compared to non-incremental approaches, allowing the sliding window aggregation framework to run efficiently. For example, according to exemplary embodiments, referring to space and time complexity, in O(n) space, the reactive aggregator data structure takes O(m+m log(n/m)) time, where m is the number of window events after the previous firing, and n is the window size at the time of firing. Thus, O(log(n)) corresponds to constant changes to the window, and O(m) corresponds to changes that overwrite the window. Herein, the term “firing” refers to output generation.

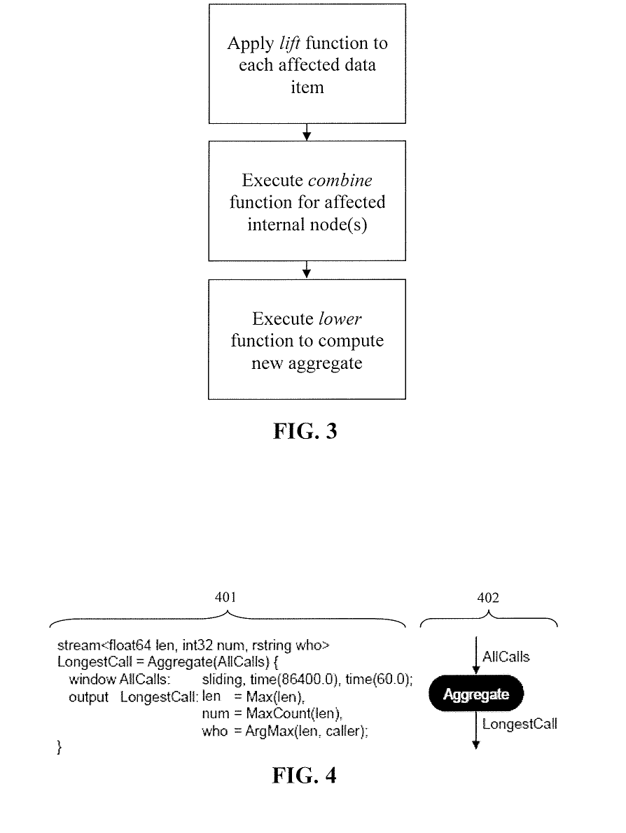

FIG. 3 is a flowchart showing an overview of a reactive aggregator that incrementally computes an aggregate function of a sliding window of tuples in a streaming application, according to an exemplary embodiment of the present invention.

Referring to FIG. 3, to respond to changes in a window, at block 301, the lift function is applied to each affected data item (e.g., each data element in the current tuples in the sliding window that has changed), the locations of the affected data items are identified in the leaf nodes of the reactive aggregator data structure, which is embodied as a balanced tree, and the values of the leaf nodes are updated. The affected leaf nodes are identified based on the data insertions and removals due to the sliding of the window. On each slide, one or more new data item can be added into the window, and similarly, one or more old data item can be removed from the window. After the leaf nodes are updated, the values of the affected leaf nodes are propagated up the tree by executing the combine function associated with an internal node that is affected by the changes at the leaf at block 302. At block 303, a new aggregate is computed by executing the lower function associated with the root node.

Reactive Aggregator

Application Developers' Perspective

From an application developer's perspective, the reactive aggregator according to exemplary embodiments of the present invention is platform agnostic. For convenience of explanation, the reactive aggregator is described herein with reference to the Streams Processing Language (SPL), which is used for application development. An SPL program describes a graph of operator instances, where each operator instance configures an operator (from the library or user-defined). It is to be understood that exemplary embodiments of the present invention are not limited to an SPL implementation.

FIG. 4 shows an SPL code example that uses the Aggregate operator from the SPL standard library, according to an exemplary embodiment of the present invention.

Referring to FIG. 4, the SPL example uses the Aggregate operator to gather statistics about phone calls. FIG. 4 shows the source code 401 used to configure the Aggregate operator instance, and the resulting stream graph 402. As shown in the stream graph 402, the input to the operator instance is a stream named AllCalls that feeds the instance with tuples describing phone calls, and the output is the LongestCall stream of tuples describing the longest calls. The core of the source code 401 includes the window and output clauses, which declaratively configure the operator's window setting and the output.

In stream computing, a stream is a conceptually infinite sequence of tuples, and a window specifies a finite subsequence of the most recent tuples in a stream at any given point in time. In the example shown in FIG. 4, the window is specified on the input stream AllCalls. The window is sliding and spans 86,400 seconds (one day). The operator fires (e.g., generates output) every 60 seconds (one minute). Each time the operator generates output, the window emits an output tuple aggregating the current window contents. Although the example shown in FIG. 4 shows a time-based window, the window is not limited thereto. For example, a variety of policies based on, for example, count, attribute-delta, and punctuations are also supported. Further, although the example shown in FIG. 4 illustrates coarse-grained firing (once per minute), windows may also be configured to fire at a finer granularity (e.g., once per incoming tuple).

The output clause in the source code 401 specifies the manner in which each attribute of the output tuple is computed by aggregating over the tuples in the window. This specification is declarative, since it describes which aggregation operation is to be used, rather than how the aggregation operation works. In the example shown in FIG. 4, len=Max(len) is the duration of the longest phone call in the window. The attribute num=MaxCount(len) is the number of phone calls having that maximum duration. The attribute who=ArgMax(len, caller) is the caller that placed the longest phone call, or, if multiple such longest calls exist, the caller for the first such record. The Aggregate operator supports operations other than the Max, MaxCount, and ArgMax operations shown in the source code 401.

Library Developers' Perspective

From a library developer's perspective, according to exemplary embodiments, each operation of the reactive aggregator may be described with three types and three functions. For example, the three types are input In, partial aggregation Agg, and output Out. The three functions are lift(v: In), combine(a: Agg, b: Agg), and lower(c: Agg). Referring to lift(v: In), Agg computes the partial aggregation for a single-tuple subwindow. Referring to combine (a: Agg, b: Agg), Agg, which may be rendered in the binary operator notation a⊕b, partial aggregations are transformed for two subwindows into the partial aggregation for the combined subwindow. Referring to lower(c: Agg), Out turns a partial aggregation for the entire window into an output.

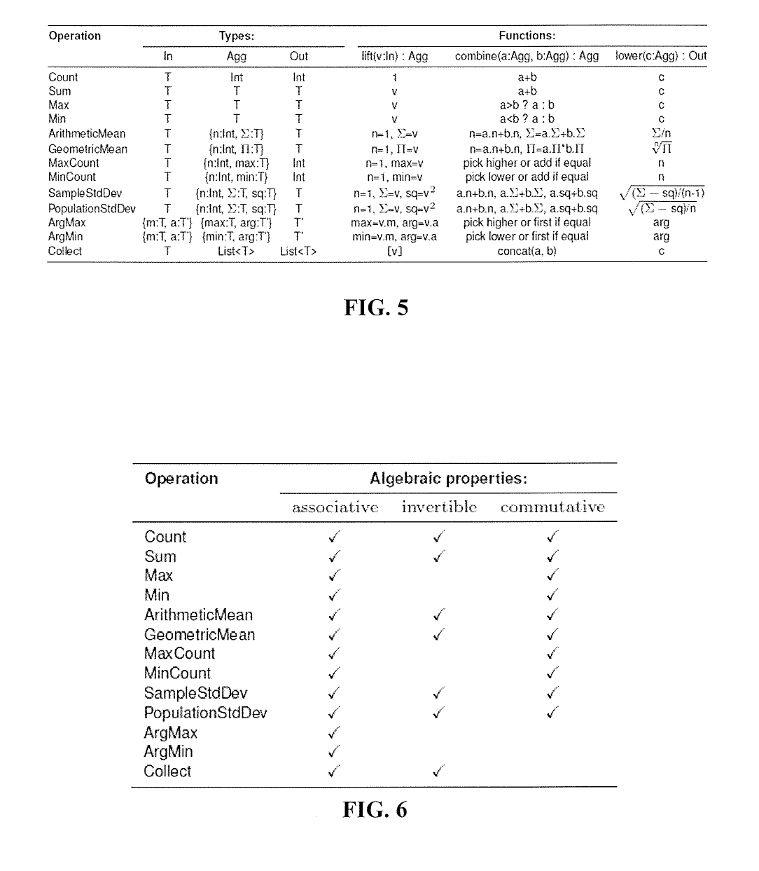

FIG. 5 shows examples of aggregation operations, as well as their types and functions, that may be implemented using custom functions according to exemplary embodiments of the present invention.

Each of the aggregation operations shown in FIG. 5 may be implemented using the custom lift, combine, and lower functions according to exemplary embodiments of the present invention. That is, the aggregation operations shown in FIG. 5 may be replaced with the lift, combine, and lower functions. For example, FIG. 5 shows the decomposition of a variety of aggregation operations into the custom lift, lower, and combine, and shows the input type In, the intermediate aggregate type Agg, and the output type Out, as well as the corresponding functions to perform the aggregation. It is to be understood that the listing of aggregation operations shown in FIG. 5 is exemplary, and other standard aggregation operations may also be implemented using the custom lift, lower, and combine functions. In FIG. 5, the combine function corresponds to the op function.

Referring to FIG. 5, the Max and ArgMax operations based on the SPL code example from FIG. 4 will be described herein for exemplary purposes. The Max operation uses the same type for In, Agg, and Out. The functions lift and lower are identity functions. The SPL source code 401 invokes the Max operation via len=Max(len). The type of len is float64, and unifies with the generic type variable T in FIG. 5. The combine function takes partial aggregation results from two subwindows, and returns a new partial aggregation for the fused subwindow. For example, referring to the Max operation, the larger value is taken.

In contrast to the Max operation, the ArgMax operation utilizes the full generality of the three types and three functions. Referring to who=ArgMax(len, caller) as shown in the source code 401 of FIG. 4, ArgMax has two parameters, and maximizes len while tracking the argument caller for which the maximum is reached. Unifying the concrete actual input type {len:float64, caller:rstring} against the generic formal input type In, which is {m:T, a:T′}, yields the substitution [T [symbol] float64, T′ [symbol] rstring]. With this substitution, type Agg is {max:float64, arg:rstring} and type Out is rstring. ArgMax.lift returns a partial aggregation for a singleton subwindow (e.g., max=len and arg=caller in the current example). ArgMax.combine takes partial aggregations from two subwindows, and yields arg and max from the subwindow that has a higher value of max. If max is the same in both subwindows, combine resolves the ambiguity deterministically by selecting arg from the first subwindow. ArgMax.lower takes a partial aggregation over the entire window, and produces the actual output. In the case of the running example ArgMax(len, caller), the output is the caller corresponding to the maximum len.

The interface according to exemplary embodiments of the present invention is general, as shown by the variety of operations in FIG. 5. In addition to providing generality across operations, the interface further yields generality across concrete types by using generic types and functions. For example, the operations work across different input types In, and the other types Agg and Out, as well as function signatures, depend on the input type In. Utilization of the combine(Agg,Agg) variant allows exemplary embodiments to break down the window into balanced subwindows, resulting in improved algorithmic complexity bounds.

Algebraic Properties

Algebraic properties can offer insight into the behavior of an aggregation operation. Algebraic properties set frameworks apart in terms of generality. For example, a framework that only works for invertible operations is less general than one that also works for non-invertible ones. The reactive aggregator according to exemplary embodiments may utilize associativity, and not utilize invertibility or commutativity. For all partial aggregation results x, y, z, a combine function rendered in binary-operator notation as ⊕ is associative if x⊕(y⊕z)=(x⊕y)⊕z. Without associativity, a combine function can only handle insertions one element at a time at the end of the queue. Associativity enables the computation to be broken down in flexible ways including, for example, balanced breakdowns that may improve algorithmic complexity bounds.

A combine function ⊕ is invertible if a known and reasonably computationally cheap function ⊖ exists such that for all partial aggregation results x, y, (x⊕y)⊖y=x. Invertibility enables handling deletions as inverse insertions, and is often used in incremental sliding-window aggregation. However, according to exemplary embodiments of the present invention, invertibility may not be utilized, resulting in a more general approach.

A combine function X is commutative if x⊕y=y⊕x holds for all partial aggregation results x, y. If the combine function is commutative, the order of the input can be ignored when computing aggregation results.

FIG. 6 shows the algebraic properties of the operations listed in FIG. 5.

Referring to FIG. 6, the common aggregations are associative, several aggregations are non-commutative, and several common aggregations are not invertible, mostly as a result of not being bijective.

Design Considerations

Referring to the Max aggregation function, Max is an example of an aggregation function that does not have an inverse, but is associative and commutative. Because Max is associative, the operator can be applied in any combination. For example, in a sliding window with x₁, x₂, x₃, and x₄, the result of max(max(x₁, x₂), max(x₃, x₄)) will be identical to max(max(max(x₁, x₂), x₃), x₄). However, since Max does not have an inverse form, when x₁ leaves the window, there is no way to “subtract” x₁ from max(x₁, x₂, x₃, x₄) to derive max(x₂, x₃, x₄). That is, there is no equivalent of x₂⊕x₃⊕x₄=(x₁⊕x₂⊕x₃⊕x₄)⊖x₁.

Exemplary embodiments of the present invention eliminate pointers from the reactive aggregator data structure as described in further detail below, resulting in a reduction in memory usage and an improvement of performance. In addition, according to exemplary embodiments, the memory used for the reactive aggregator data structure is allocated once, at creation, rather than in multiple small requests. Further, when the reactive data structure is embodied in a tree structure, sibling nodes that are accessed together remain in a consecutive block. Further still, the logic used to handle tuple arrival, tuple eviction, and firing is separated, resulting in a modular framework.

Design Overview

A tuple enters into the framework when the window logic informs the reactive aggregator of the tuple's arrival. Upon arrival, the tuple is lifted using the lift function and is stored in a buffer maintained by the reactive aggregator. The lifted tuple remains in the buffer until the window logic instructs the reactive aggregator to evict it. The reactive aggregator can be probed for the current window's aggregate value, which may be derived using the combine function. The result may then be lowered using the lower function and returned to the stream processing system. Although the contents of the window is stored by the reactive aggregator, to support a multitude of window policies, the reactive aggregator may utilize a separate window-logic module to determine when a new tuple arrives, which existing tuple to evict, and when the aggregation value is needed.

Since the reactive aggregator framework according to exemplary embodiments of the present invention utilizes an incremental approach to maintaining the aggregate as the window changes, there is only a small change to the window, and the reactive aggregator performs a decreased amount of work. When utilizing the reactive aggregator with the lift, combine, and lower functions, a number of partial aggregate results is maintained. When the window changes, the partial aggregate results are updated and used to derive the aggregate in a more efficient manner than re-computing all changes in the entire window.

Consider an example in which lift, combine, and lower are constant-time functions, and Agg is a constant-sized data type. In this example, the reactive aggregator data structure takes O(m+m log(n/m)) time, where in is the number of window events after the previous firing, n is the window size at the time of firing, and O(n) space is consumed. Thus, it can be seen that O(log n) time for constant changes to the window and O(m) for changes that completely overwrites the window, an amount that is already needed to make m changes. To meet these bounds, exemplary embodiments include a fixed-capacity data structure that acts as a container holding n values while efficiently maintaining the aggregate of the contained data, as described in further detail below. The fixed-capacity data structure may be embodied, for example, as a balanced tree on n leaves (e.g., a complete binary tree on n leaves), which holds the windows elements. The tree may be efficiently updated and queried by, for example, maintaining, at each internal node of the tree, the aggregate of the data in the leaves below it.

The fixed-capacity data structure may be kept “flat” in consecutive memory in a pointer-free layout, as described in further detail below. For example, the data structure may be stored in a pointer-free array in memory. As a result, necessary memory can be allocated at creation and sibling nodes may be placed next to each other, reducing dynamic memory allocation calls in the overall framework, and improving cache friendliness since these nodes are frequently accessed together.

Fixed-Sized Aggregator

A size-n fixed-sized aggregator (FAT) for ⊕: D×D→D is a fixed-capacity data structure that maintains values a[1], . . . , a[n]εD while allowing for updates to the values and queries for the aggregate value of any prefix and suffix.

An instance of the data structure is created by calling new((val₁, . . . , valₙ)), which initializes a[i]=valᵢ and sets the capacity to n. Once created, the instance of the data structure supports the following operations:
get(i) returns the value of a[i]
update(<(loc₁, val₁), . . . , (locₘ, valₘ)>), where each locᵢ is a unique location, writes valᵢ to a[locᵢ] for each i
aggregate( ) produces the result of a[1]⊕ . . . ⊕a[n]
prefix(i) produces the result of a[i]⊕ . . . ⊕a[i]
suffix(j) produces the result of a[j]⊕ . . . ⊕a[n]

Since exemplary embodiments of the present invention utilize an abstraction implementation, an operation's cost may be measured in terms of the number of ⊕ operations. In the examples described herein, it as assumed that n is a power of two.

A size-n FAT can be maintained such that (i) new makes n−1 calls to ⊕, (ii) for m writes, update requires at most m(1+┌ log(n/m)┐) calls to ⊕, and (iii) prefix(i) and suffix(j) each require at most log₂(n) calls to ⊕. Further, aggregate( ) requires no ⊕ calls.

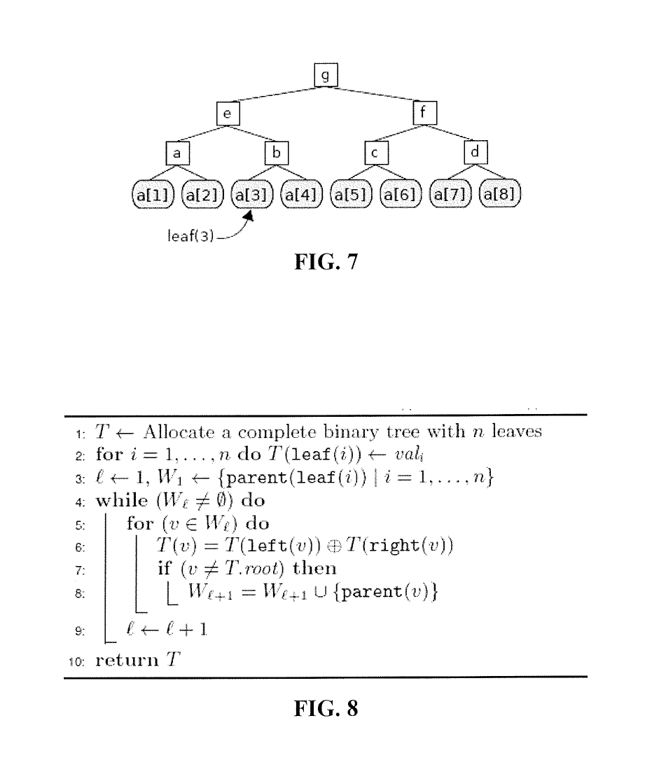

FIG. 7 shows an example of a fixed-sized aggregator embodied as a binary tree having 8 leaf nodes, according to an exemplary embodiment of the present invention.

According to exemplary embodiments of the present invention, FAT may be maintained as a complete binary tree T with n leaves, which store the values a[1], a[2], . . . , a[n]. The leaf node containing a[i] (e.g., the i-th leaf) may be referred to as leaf(i). Each internal node v keeps a value T(υ)εD that satisfies the invariant T(v)=T(left(v)) ⊕T(right(v)), where left(v) and right(v) denote the left child and the right child of v, respectively. As a result of associativity, mathematical induction implies that when v is the root of a subtree whose leaves are a[i], a[i+1], . . . , a[j], then T(v)=a[i]⊕ . . . ⊕a[j].

Referring to FIG. 7, an example of a binary tree for FAT has 8 leaves. The leaf node corresponding to a[i] is denoted by leaf(i). For example, leaf(3) refers to the leaf that stores a[3]. Since, by definition of the FAT tree, T(a)=a[1]⊕a[2], T(c)=a[5]⊕a[6], and T(d)=a[7]⊕a[8]. As a result, T(f)=T(c)⊕T(d)=(a[5]⊕a[6])⊕(a[7]⊕a[8]).

It is to be understood that although the example described with reference to FIG. 7 refers to the data structure being embodied as a binary tree, exemplary embodiments are not limited thereto. For example, the data structure may be embodied as any balanced tree.

Creating an Instance

A user may create a new FAT instance by invoking new with the values valᵢ, i=1, . . . , n. Once invoked, new builds the tree structure and computes the value for each internal node, satisfying T(v)=T(left(v))⊕T(right(v)).

FIG. 8 shows pseudocode for the new function, according to an exemplary embodiment of the present invention.

Referring to FIG. 8, the new function first allocates a complete binary tree containing n leaves, and stores the value valᵢ in the i-th leaf (lines 1-2). The new function then proceeds bottom-up, level by level, computing T(v)←T(left(v))⊕T(right(v)) for every internal node v. Since the computation for a level depends only on the computation of the levels below it, T(v)=T(left(v))⊕T(right(v)) holds true at all internal nodes once the new function has finished executing.

Consider an example in which new is called with <x₁, x₂, . . . , x₈>. In this example, a tree structurally similar to the tree shown in FIG. 7 is created, and W₁={a, b, c, d}, where for each υεW₁, T(v)←T(left(v))⊕T(right(v)) is computed. The new function then proceeds to work on W₂={e, f} and W₃={g}. In this example, the number of ⊕ calls is |W₁|+|W₂|+|W₃|=4+2+1=7.

In general, referring to the cost of new in terms of the number of ⊕ calls, for each level l, the number of ⊕ calls is |Wₗ| (see line 6). Therefore, to obtain the total number of ⊕ calls, the sizes of all Wₗ's may be summed. Wₗ, which corresponds to the sets of the parents of the leaves, is the set of all level-1 nodes, and inductively, Wₗ, which corresponds to the sets of the parents of Wₗ₋₁, is the set of all level-1 nodes. As a result, |Wₗ|=n/2^{l}. Thus, the number of ⊕ calls is

$${\sum }_{𝓁 = 1}^{{log}_{2} n} \vert {W}_{𝓁} \vert = {\sum }_{𝓁 = 1}^{{log}_{2} n} \frac{n}{{2}^{𝓁}} = \frac{n}{2} + \frac{n}{4} + … + 1 = n - 1.$$

Updating Values

A user may modify the contents stored in FAT by calling the update function. The update function incorporates a list of changes to be made into FAT by first updating the corresponding a[.] values, and then updating the internal nodes affected by the changes.

According to exemplary embodiments of the present invention, only internal nodes that are affected by changes are updated. Consider an example in which one a[i] is modified. In this example, only the internal nodes whose values depend on a[i] should be updated. Only the nodes that are on the path from a[i] to the root should be updated. These nodes are characterized by T(v)=a[i]⊕ . . . ⊕a[j]. Referring to FIG. 7, if a[3] is altered, only the nodes b, e, and g should be updated, and nodes b, e, and g are updated in this order as a result of their dependencies.

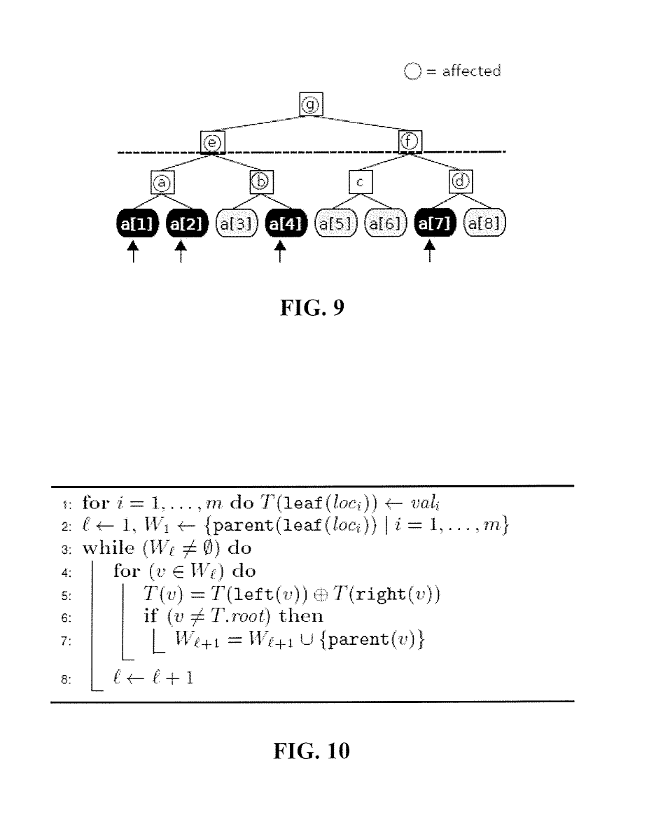

FIG. 9 shows an example of an 8-leaf FAT tree being updated in response to modifications made to the tree, according to an exemplary embodiment of the present invention.

In an example in which multiple modifications are made, an internal node should be updated if a leaf in its subtree is modified. However, dependencies may exist between these nodes, and as a result, certain nodes may need to be updated in a certain order. For example, referring to FIG. 9, consider an example in which a[1], a[2], a[4], and a[7] are modified. Based on these modifications, nodes a, b, d, e, f, and g, which are circled in FIG. 9, should be updated. Although it does not matter which order nodes a, b, and d are updated, node e should not be updated before nodes a and b are updated. The dashed horizontal line in FIG. 9 marks the location of l* used in the current analysis.

To resolve this internal dependency, exemplary embodiments utilize the principle of change propagation to identify and update the internal nodes affected by the modifications. For example, when a node is updated, the update may trigger the nodes that depend on this node to be updated.

FIG. 10 shows pseudocode for an update function, according to an exemplary embodiment of the present invention.

Referring to FIG. 10, the update function modifies the leaves corresponding to the updates (line 1). The update function then constructs W₁, which is the set of nodes in level-1 (one level above the leaves) that are to be updated. If v is changed, parent(v) is updated. As shown in lines 2-8, the update function proceeds bottom-up, level by level (e.g., 1=1, 2, . . . etc.), updating the affected nodes W₁, and scheduling the nodes that depend on them by adding these nodes to Wₗ₊₁.

Referring again to FIG. 9, after updating the leaves, W₁={a,b,d} is identified. The order for which processing is carried out for these nodes may vary depending on the current implementation. While processing, W₁, W2 is populated, resulting in W2={e,f} This process is repeated, yielding W₃={g}.

The number of ⊕ calls may be analyzed by upper-bounding the number of calls per level of the tree. The number of calls at level l is |Wₗ|. Thus, the total number of invocations may be represented as:

$$\# of calls = {\sum }_{𝓁 \geq 1} \vert {W}_{𝓁} \vert$$

To proceed, an upper bound on the size of each Wₗ is derived as a function of the number of modified leaves m and the level number l:

For 1≦l≦log₂n,

|Wₗ|≦min{m,n/2^{l}}.

Assuming that 1≦l≦log₂n, an internal node belongs to Wₗ if and only if it is on the leaf-to-root path of a modified leaf. Since exactly m leaves were modified, there cannot be more than m leaf-to-root paths passing through level l. Thus, |Wₗ|≦m. Further, since Wₗ is a subset of the nodes in level l, |Wₗ|≦n/2^{l}. Thus, |Wₗ|≦min{m, n/2^{l}}.

Referring again to:

$$\# of calls = {\sum }_{𝓁 \geq 1} \vert {W}_{𝓁} \vert$$

The summation may be broken into a top part and a bottom part. The top part accounts for level l*=1+┌ log₂(n/m)┐ and above, and the bottom part accounts for the levels below l*. Thus:

# of calls=top+bottom,
where

$$top = {\sum }_{𝓁 = {𝓁}^{*}}^{{log}_{2} n} \vert {W}_{𝓁} \vert and bottom = {\sum }_{𝓁 = 1}^{{𝓁}^{*} - 1} \vert {W}_{𝓁} \vert .$$

These two cases may be handled differently since most leaf-to-root paths have yet to merge together in the bottom part of the tree, whereas these paths have sufficiently joined together in the top part. The dashed line in FIG. 9 illustrates this division.

To analyze the top part, let λ=n/2^{l*}. Since, ┌x┐≧x for x≧0, it follows that:

$$λ = \frac{n}{{2}^{1} + [ {log}_{2} ( n / m ) ]} \leq \frac{n / 2}{{2}^{{log}_{2} ( n / m )}} = \frac{n / 2}{n / m} = m / 2.$$

### Therefore:

$$top = {\sum }_{𝓁 = {𝓁}^{*}}^{{log}_{2} n} \vert {W}_{𝓁} \vert \leq {\sum }_{𝓁 = {𝓁}^{*}}^{{log}_{2} n} min \{ m , n / {2}^{𝓁} \} \leq {\sum }_{𝓁 = {𝓁}^{*}}^{{log}_{2} n} \frac{n}{{2}^{{𝓁}^{*}}} = \frac{n}{{2}^{{𝓁}^{*}}} + \frac{n}{{2}^{{𝓁}^{*}} + 1} + … + 1 [ min \{ a , b \} \leq b ] \leq \frac{2 n}{{2}^{{𝓁}^{*}}} = 2 λ \leq m , \\ bottom = {\sum }_{𝓁 = 1}^{{𝓁}^{*} - 1} \vert {W}_{𝓁} \vert \leq {\sum }_{𝓁 = 1}^{{𝓁}^{*} - 1} m \leq ( {𝓁}^{*} - 1 ) m = ⌈ {log}_{2} ( n / m ) ⌉ \cdot m .$$

Thus, the total number of ⊕ calls is at most:

m+┌ log₂(n/m)┐·m.

Answering Queries

A user may request the aggregate of the entire data, or any prefix or suffix using the aggregate, prefix, and suffix operations. The aggregate operation requires no additional work, as the function only returns the value at the root of the tree. The prefix and suffix operations may be supported with minimal work since any query may be answered by combining at most log₂(n) values in the tree, as described below. According to exemplary embodiments, the prefix and suffix operations may be used to handle non-commutative aggregations.

Referring to the prefix operation, an example is described herein corresponding to answering prefix(7) on FAT with reference to FIG. 7. Rather than directly computing a[1]⊕ . . . ⊕a[7], a smaller number of segments corresponding to the nodes of T may be utilized. For example:

$$\begin{matrix}a [ 1 ] ⊕ … ⊕ a [ 7 ] = ( \underbrace{a [ 1 ] ⊕ … ⊕ a [ 4 ]}_{T ( e )} ) ⊕ ( ( \underbrace{a [ 5 ] ⊕ a [ 6 ]}_{T ( c )} ) ⊕ a [ 7 ] ) \\ = T ( e ) ⊕ T ( c ) ⊕ a [ 7 ] .\end{matrix}$$

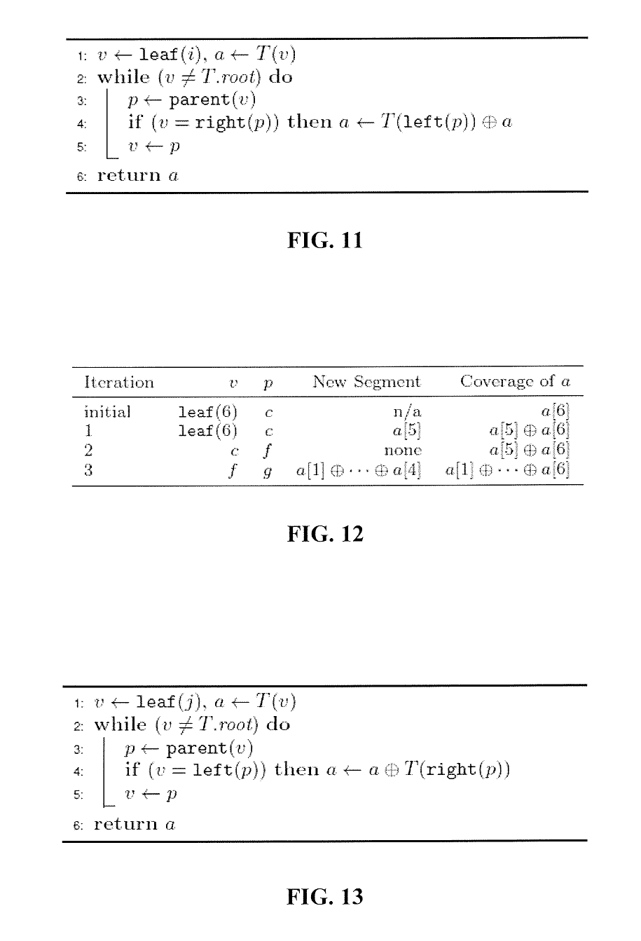

FIG. 11 shows a process that performs a bottom-up leaf-to-root traversal in a balanced tree, according to an exemplary embodiment of the present invention.

The process shown in FIG. 11 may be used to perform one leaf-to-root traversal, and may be used to handle an operation for prefix(i). For example, the process starts at the leaf node leaf(i), setting a=a[i] (line 1). As the process traverses up the tree, more segments are incorporated into a, extending the coverage of a further to the left. At line 4, a is updated to T(left(p))⊕a if v is the right child of its parent. If v is the right child of p=parent(v), node v's sibling (e.g., the left child of p) contains an extension of a, a new prefix segment next to what a has included.

FIG. 12 is a table showing the execution trace of running prefix(6) on the FAT structure shown in FIG. 7, according to an exemplary embodiment of the present invention.

Referring to FIGS. 7 and 11-12, the initial iteration shows the state of the variables after line 1. Each subsequent iteration shows the state of the variables after line 4. In terms of complexity, the process traverses a leaf-to-root path, making at most one ⊕ call at each node. As a result, the number of ⊕ calls is at most log₂(n). After each execution of line 4, a contains the aggregate of all of the leaves to the left of a[i] in the subtree rooted at p. FIG. 13 is a table showing a symmetric suffix operation relative to FIG. 11, according to an exemplary embodiment of the present invention.

FlatFAT: Storing FAT in Memory

FlatFAT refers to an efficient implementation of the FAT data structure, according to an exemplary embodiment of the present invention. Since FAT is structurally static, FlatFAT may allocate the necessary memory at creation and ensure that sibling nodes are placed next to each other. Utilizing a FlatFAT implementation may reduce dynamic memory allocation calls in the overall framework, and may improve cache friendliness of these nodes, which tend to be accessed together.

FlatFAT is implemented by adopting a numbering scheme that is frequently used in array-based binary heap implementations. For example, assume T is a size-n FAT (e.g., T is a tree having 2n−1 nodes). These nodes may be represented as an array of length 2n−1 using a recursive numbering scheme in which the root node is at position h(T.root)=1, where for a node v, the left and right children of v are located at:

h(left(υ))=2h(υ) and k(right(υ))=2h(υ)+1.

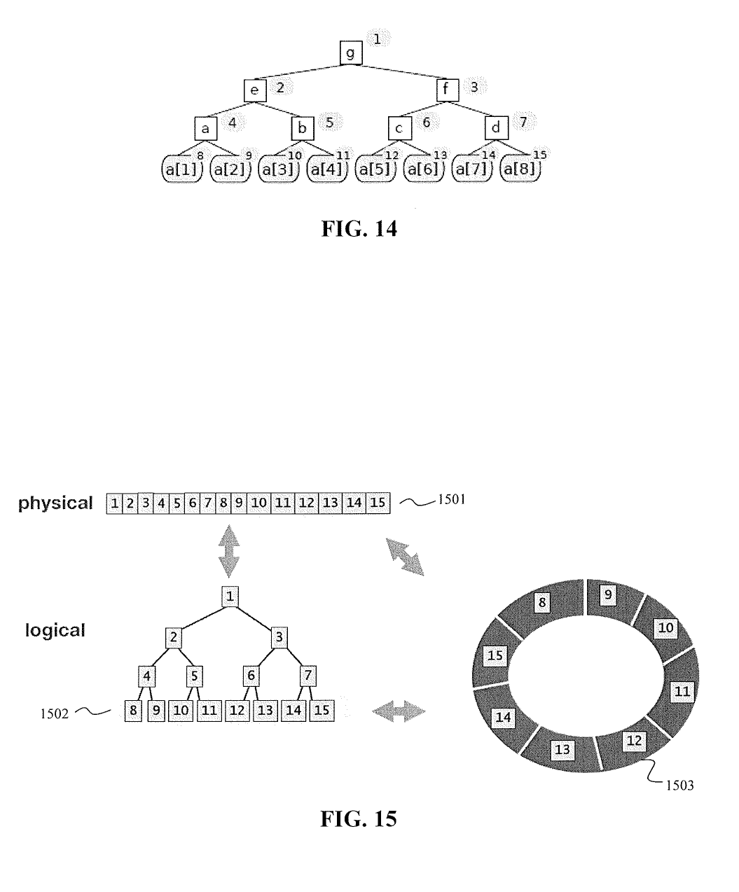

FIG. 14 shows an example of a numbering scheme utilized by a FlatFAT implementation on a size-8 FAT, according to an exemplary embodiment of the present invention.

Referring to FIG. 14, a size-8 FAT is stored by FlatFAT. In FIG. 14, the tree is a perfect binary tree having 8 leaves in an array of length 15, however it is to be understood that the FlatFAT implementation is not limited thereto. In FIG. 14, the corresponding locations are shown next to the nodes.

A feature of the mapping used in a FlatFAT implementation is that each of the navigation operations used in FAT processes takes O(1) time. The mapping allows for convenient navigation in both a downward direction (e.g., left, right) and an upward direction (e.g., parent) of the tree, as well as random access to the leaves (e.g., leaf) of the tree. For any node v other than the root:

h(parent(υ))=└h(υ)/2┘

The location of the i-th leaf (e.g., the leaf corresponding to (I[i]) is utilized to access a leaf node. The location of the i-th leaf is h(leaf(i))=n+i−1.

For a constant-time binary operator, a size-n FlatFAT may be maintained such that (i) new takes O(n) time, (ii) for m writes, update takes O(m+m log(n/m) time, (iii) prefix(i) and suffix(j) each take O(log₂(n)) time, and (iv) aggregate( ) takes O(1) time.

Reactive Aggregator Using FlatFAT

The reactive aggregator is the interface between the window logic and the internal representation according to exemplary embodiments of the present invention. The reactive aggregator translates window events into actions on FlatFAT in order to respond to the events. The window events may be translated, for example, when a new tuple arrives, when an existing tuple is to be evicted, and when the aggregation value is needed. Herein, the reactive aggregator implementation using FlatFAT will first be described with reference to maintaining the window under tuple arrival and tuple eviction, and then with reference to providing the aggregate upon request.

According to exemplary embodiments, the reactive aggregator pairs the FlatFAT implementation with a resize process that determines the size of FlatFAT. The reactive aggregator views the slots of FlatFAT (e.g., a[1], . . . , a[n]) as an array lf length n. This space may be used to implement, for example, a circular buffer (e.g., a ring buffer), where the lifted elements of the sliding window are stored. It is to be understood that exemplary embodiments are not limited to a circular buffer.

FIG. 15 shows the relationship between data stored in a physical representation and different logical representations, according to an exemplary embodiment of the present invention.

Referring to FIG. 15, data may be stored in a physical location 1501 in a continuous piece of memory (e.g., in a consecutive chunk of linear memory space). Corresponding logical representations of this data may include, for example, a balanced tree 1502 or a circular buffer 1503. The circular buffer 1503 may include data corresponding to the leaves of the balanced tree 1502.

Although exemplary embodiments of the present invention store the data structure in memory in a pointer-free layout, in exemplary embodiment that utilize a circular buffer, a front pointer and a back pointer may be utilized to mark the boundaries of the circular buffer. Unfilled FlatFAT slots may be given a special marker, denoted by ⊥, which short-circuits the binary operator to return the other value: x⊕⊥=x and ⊥⊕y=y. This marker may not be utilized in certain implementations (e.g., FIFO windows, as described further below).

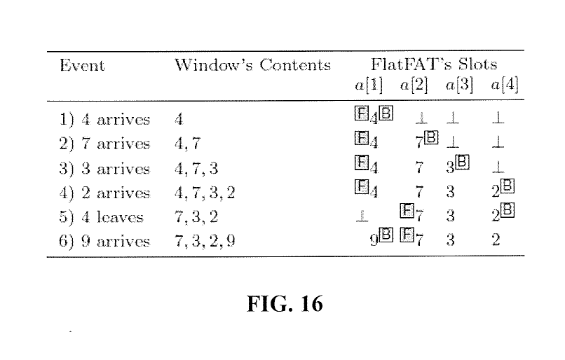

FIG. 16 shows a sequence of events issued by window logic when maintaining a sliding window keeping the latest four numbers, according to an exemplary embodiment of the present invention.

In an exemplary embodiment, the reactive aggregator first creates a FlatFAT instance with a default capacity, filling all slots with ⊥. As tuples enter into the window, the tuples are inserted into the circular buffer. As tuples leave the window, the tuples are removed from the buffer, and their locations are marked with ⊥. For example, referring to FIG. 16, an instance of a sliding window that keeps the latest four numbers, as well as the manner in which the window is physically represented, is illustrated. FIG. 16 further illustrates the locations of the front pointer (F) and the back pointer (B), which respectively indicate the starting point and the ending point of the circular buffer.

In exemplary embodiments in which FIFO is not utilized, holes may exist in the circular buffer. The presence of holes may potentially create a situation in which the buffer is not able to receive more tuples, even though room may exist in the middle of the window. In response, the buffer may be occasionally compacted using a compact operation.

The compact operation, as well as a resize operation, are computationally expensive. For example, the compact operation scans the entire buffer to pack the buffer. Similarly, the resize operation creates a new FlatFAT, packs the data, and copies the data. Thus, according to exemplary embodiments, the compact and resize operations may be used sparingly. For example, assuming that count denotes the number of actual elements in the buffer (e.g., excluding ⊥) and that n is the capacity of FlatFAT, upon receiving a tuple and determining that the buffer is full, if count≦3n/4, the compact operation may be run. Otherwise, resize may be run to double the capacity. Further, after evicting a tuple, if count<n/4, resize may be used to shrink the capacity by half. After a resize operation, the buffer is between 3n/8 and n/2 full, and after a resize or compact operation, there are no holes remaining in the buffer.

Referring to the compact operation, when the compact operation is performed, at least n/4 evictions have occurred since the last time that no holes were present, since the buffer is full and count≦3n/4. The O(n) cost of compacting is charged to the evictions that created the holes, at a cost of O(1) per eviction. No holes exist in the buffer after a resize or compact operation.

Referring to the resize operation, when the capacity is to be doubled, at least n−n/2=n/2 arrivals have occurred since the last resize operation, and since the buffer is full and immediately after the last resize operation, the buffer may only be between 3n/8 and n/2 full. The O(n) cost of doubling is charged to these arrivals at a cost of O(1) per arrival. Similarly, when the capacity is shrunk in half, at least 3n/8−n/4=n/4 evictions have occurred since the last resize operation, and since the buffer is n/4 full and immediately after the last resize operation, the buffer may only be between 3n/8 and n/2 full. The O(n) cost of shrinking to these evictions is charged at O(1) per eviction.

Reporting the Aggregate Result

The manner in which the reactive aggregator derives the aggregate of the current window according to exemplary embodiments of the present invention will be described herein.

The window contents of FlatFAT are stored in the leaves, and its aggregate( ) operation may return the value of a[1]⊕ . . . ⊕a[n] at no cost.

An inverted buffer scenario refers to a scenario in which the ordering in the linear space a[1], a[2], . . . , a[n] differs from the ordering in the circular buffer (e.g., the window order). For example, referring again to FIG. 16, in which the locations of the front pointer (F) and the back pointer (B) respectively indicate the starting and ending points of the circular buffer, events 1-5 occur as expected—the window order is identical to FlatFAT's order. In event 5, element 9 is correctly inserted into a[1]. However, while the window order is 7, 3, 2, 9, the physical order is inverted. As a result, if the aggregate operation were called at this point, an incorrect result (unless the operator is commutative) of 9⊕7⊕3⊕2 would be generated.

According to exemplary embodiments, the correct aggregate in an inverted buffer scenario may be derived. The correct aggregate may be derived by splitting the circular buffer in the middle due to the linear address space. Thus, the correct aggregate may be indicated by suffix(F)⊕prefix(B). The maximum cost is O(log₂n).

FIFO Implementation

Exemplary embodiments of the present invention may be utilized in a FIFO (first-in, first-out) implementation, in which the first tuple to arrive in the window is the first tuple to leave the window. For example, in SPL, both count-based and time-based policies may utilize FIFO ordering.

When exemplary embodiments are utilized with a FIFO window, the area from the front buffer to the back buffer (wrapping around the array boundary) is always occupied (e.g., no holes exist). As a result, the reactive aggregator according to exemplary embodiments does not utilize the compact operation, which results in simplifying the resize operation. Accordingly, ⊥ need not be explicitly stored in unused slots. Rather, the buffer's demarcation may be incorporated into the update operation, resulting in unused slots being automatically skipped. When an inverted buffer scenario occurs, the unoccupied area is located between the leaf-to-root path of the back buffer and that of the front buffer. When the buffer is normal, the occupied area is located between the leaf-to-root path of the front buffer and that of the back buffer.

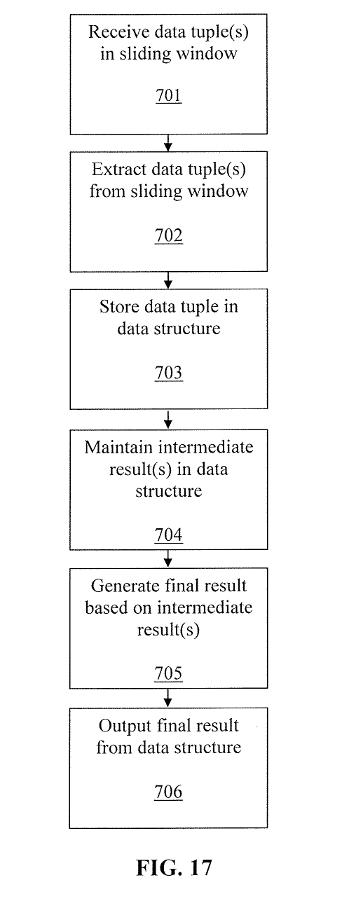

FIG. 17 is a flowchart showing a method of incrementally computing an aggregate function of a sliding window in a streaming application according to an exemplary embodiment of the present invention.

At block 701, a plurality of data tuples is received in the sliding window. At block 702, at least one data tuple of the plurality of data tuples is extracted from the sliding window. The at least one extracted data tuple is stored in a data structure in a memory at block 703. As described above, the data structure may be a balanced tree, and the at least one data tuple may be stored in leaf nodes of the balanced tree. At block 704, at least one intermediate result is maintained in at least one internal node of the balanced tree. The at least one intermediate result corresponds to a partial window aggregation. At block 705, a final result in the balanced tree is generated based on the at least one intermediate result. The final result corresponds to a final window aggregation. At block 706, the final result is output from the balanced tree.

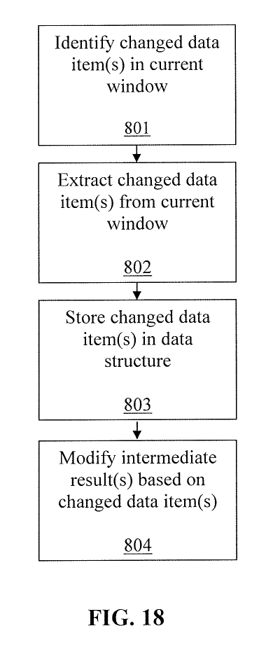

FIG. 18 is a flowchart showing a method of maintaining at least one intermediate result in a balanced tree while implementing a method of incrementally computing an aggregate function of a sliding window in a streaming application according to an exemplary embodiment of the present invention.

In an exemplary embodiment, maintaining at least one intermediate result in the balanced tree (block 703) may include identifying at least one changed data item in a current data tuple of the plurality of data tuples currently in the sliding window at block 801. The at least one changed data item is relative to a previous data tuple of the plurality of data tuples previously in the sliding window. At block 802, the at least one changed data item is extracted from the current data tuple. At block 803, the at least one extracted changed data item is stored in at least one of the leaf nodes of the balanced tree. At block 804, the at least one intermediate result is modified based on the at least one extracted changed data item.

According to exemplary embodiments of the present invention, a general and automatic approach to incrementally computing sliding window aggregates in streaming applications is provided. As described above, exemplary embodiments avoid the need to compute the aggregate every time the aggregate is generated, resulting in a more efficient approach. Further, exemplary embodiments are not limited to aggregation-specific solutions (e.g., solutions that only work for specific functions), restricted scenarios (e.g., an insert-only model such as tumbling), or scenarios that are limited to only aggregate functions that have an inverse.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

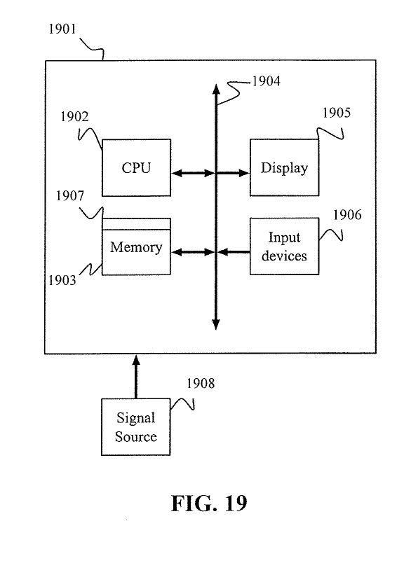

Referring to FIG. 19, according to an exemplary embodiment of the present invention, a computer system 1901 for implementing aspects of the present invention can comprise, inter alia, a central processing unit (CPU) 1902, a memory 1903 and an input/output (I/O) interface 1904. The computer system 1901 is generally coupled through the I/O interface 1904 to a display 1905 and various input devices 1906 such as a mouse and keyboard. The support circuits can include circuits such as cache, power supplies, clock circuits, and a communications bus. The memory 1903 can include random access memory (RAM), read only memory (ROM), disk drive, tape drive, etc., or a combination thereof. The present invention can be implemented as a routine 1907 that is stored in memory 1903 and executed by the CPU 1902 to process the signal from the signal source 1908. As such, the computer system 1901 is a general-purpose computer system that becomes a specific purpose computer system when executing the routine 1907 of the present invention.

The computer platform 1901 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described exemplary embodiments of the present invention, it is noted that modifications and variations can be made by persons skilled in the art in light of the above teachings. It is therefore to be understood that changes may be made in exemplary embodiments of the invention, which are within the scope and spirit of the invention as defined by the appended claims. Having thus described the invention with the details and particularity required by the patent laws, what is claimed and desired protected by Letters Patent is set forth in the appended claims.

What is claimed is:

1. A method of incrementally computing an aggregate function of a sliding window in a streaming application, comprising:
receiving a plurality of data tuples in the sliding window;
extracting, by a processor, at least one data tuple of the plurality of data tuples from the sliding window;
storing the at least one extracted data tuple in a data structure in a memory,
wherein the data structure comprises a balanced tree and the at least one data tuple is stored in leaf nodes of the balanced tree;
maintaining, by the processor, at least one intermediate result in at least one internal node of the balanced tree, wherein the at least one intermediate result corresponds to a partial window aggregation;
generating, by the processor, a final result in the balanced tree based on the at least one intermediate result, wherein the final result corresponds to a final window aggregation; and
outputting the final result from the balanced tree.

2. The method of claim 1, wherein maintaining the at least one intermediate result comprises:
identifying at least one changed data item in a current data tuple of the plurality of data tuples currently in the sliding window,
wherein the at least one changed data item is relative to a previous data tuple of the plurality of data tuples previously in the sliding window;
extracting the at least one changed data item from the current data tuple;
storing the at least one extracted changed data item in at least one of the leaf nodes of the balanced tree; and
modifying the at least one intermediate result based on the at least one extracted changed data item.

3. The method of claim 2, wherein modifying the at least one intermediate result comprises modifying a plurality of intermediate results stored in a plurality of internal nodes located at different levels within the balanced tree, and the plurality of internal nodes are modified in the balanced tree using a bottom-up traversal.

4. The method of claim 3, wherein only internal nodes of the plurality of internal nodes affected by the at least one identified changed data item are modified.

5. The method of claim 2, wherein the at least one changed data item corresponds to new data added to the current data tuple in the sliding window or old data removed from the current data tuple in the sliding window.

6. The method of claim 2, further comprising:
modifying the final result in the balanced tree based on the at least one modified intermediate result.

7. The method of claim 2, further comprising storing the balanced tree in the memory in a pointer-free layout.

8. The method of claim 7, wherein the balanced tree is stored in the memory in a pointer-free array.

9. The method of claim 2, wherein the final result is stored in a root node of the balanced tree.

10. The method of claim 2, wherein the final result comprises an output data tuple having an aggregate value based on an aggregation of all of the plurality of data tuples.

11. The method of claim 2, wherein the balanced tree is a binary tree.

12. A computer program product for incrementally computing an aggregate function of a sliding window in a streaming application, the computer program product comprising a computer readable storage medium having program instructions embodied therewith, the program instructions executable by a processor to cause the processor to perform a method comprising:
receiving a plurality of data tuples in the sliding window;
extracting at least one data tuple of the plurality of data tuples from the sliding window;
storing the at least one extracted data tuple in a data structure in a memory,
wherein the data structure comprises a balanced tree and the at least one data tuple is stored in leaf nodes of the balanced tree;
maintaining at least one intermediate result in at least one internal node of the balanced tree, wherein the at least one intermediate result corresponds to a partial window aggregation;
generating a final result in the balanced tree based on the at least one intermediate result, wherein the final result corresponds to a final window aggregation; and
outputting the final result from the balanced tree.

13. The computer program product of claim 12, wherein maintaining the at least one intermediate result comprises:
identifying at least one changed data item in a current data tuple of the plurality of data tuples currently in the sliding window,
wherein the at least one changed data item is relative to a previous data tuple of the plurality of data tuples previously in the sliding window;
extracting the at least one changed data item from the current data tuple;
storing the at least one extracted changed data item in at least one of the leaf nodes of the balanced tree; and
modifying the at least one intermediate result based on the at least one extracted changed data item.

14. The computer program product of claim 13, wherein modifying the at least one intermediate result comprises modifying a plurality of intermediate results stored in a plurality of internal nodes located at different levels within the balanced tree, and the plurality of internal nodes are modified in the balanced tree using a bottom-up traversal.

15. The computer program product of claim 14, wherein only internal nodes of the plurality of internal nodes affected by the at least one identified changed data item are modified.

16. The computer program product of claim 13, wherein the at least one changed data item corresponds to new data added to the current data tuple in the sliding window or old data removed from the current data tuple in the sliding window.

17. The computer program product of claim 13, wherein the method further comprises:
modifying the final result in the balanced tree based on the at least one modified intermediate result.

18. The computer program product of claim 13, wherein the method further comprises storing the balanced tree in the memory in a pointer-free layout.

19. The computer program product of claim 18, wherein the balanced tree is stored in the memory in a pointer-free array.

20. The computer program product of claim 2, wherein the final result is stored in a root node of the balanced tree.
